(19) United States
(12) Patent Application Publication
(10) Pub. No.: US 2014/0238747 A1
(43) Pub. Date: Aug. 28, 2014

(54) Auger stand for a utility truck and method of using same

(71) Applicant: Paul J. Fabian, Two Rivers, WI (US)

(72) Inventor: Paul J. Fabian, Two Rivers, WI (US)

(21) Appl. No.: 13/815,362

(22) Filed: Feb. 25, 2013

(51) Int. Cl. E21B 7/02; F16M 11/00

(52) U.S. Cl. CPC E21B 7/02; F16M 11/00
USPC 175/57; 248/163.1; 248/166

(57) ABSTRACT

An auger stand is provided for a utility truck with a boom, motor and auger to install telephone poles. The stand securely holds the nine foot, 350 pound auger in an upright position to facilitate its detachment from and reattachment to a drive shaft of the motor. Without laying the auger down, the truck boom and motor are then used to install pole anchors or perform other tasks. The auger stand has a base with several radially extending legs that form a stabile platform that rests on the ground. A collar is secured near the top of the auger shaft. Several ratchet straps join the outer ends of the legs to the auger collar to form a stable pyramid structure that holds the auger upright. The legs folds up to facilitate transport and storage.

### TECHNICAL FIELD OF THE INVENTION

The present invention relates to an auger stand for a utility truck with a mechanical boom for installing telephone poles, and a method of using the stand to facilitate disconnecting the auger from the boom after digging a post hole, storing it in an upright position while the truck installs pole anchors, and reconnecting the auger to the boom to dig another post hole.

### BACKGROUND OF THE INVENTION

Our electric power grid is supported by millions of utility poles throughout the country. Utility or telephone poles are installed on all kinds of terrain in all parts of the country. To firmly plant the poles and prevent them from leaning or tipping over time, each pole is set in a pre-dug hole that is typically five to seven feet deep depending on the height of the pole. The hole has a diameter slightly larger than the eighteen inch diameter of a typical utility pole. Augers for digging telephone pole holes are typically about eight or nine feet tall, and are robustly designed for durability and ruggedness to dig holes in a wide variety of ground conditions. Although the blades of the auger are not particularly sharp, their helical shape make it difficult for a worker to firmly grasp the auger. As a result, telephone pole augers are heavy, unwieldy and dangerous to handle, particularly by a single worker.

Telephone pole augers are attached to a motor on the free end of mechanical boom of a utility truck. These trucks are often referred to as auger-trucks, derrick diggers or bucket trucks. The truck is typically anchored or otherwise firmly set in place during the use of the boom. The boom is extended, retracted, rotated and raised or lowered to position the auger at a desired location relative to the truck. The boom has a motor at its free end. The motor has an output shaft or drive rod for coupling to various attachments, such as the utility pole auger. The utility truck supplies hydraulic, electric or mechanical power to the motor to turn or rotate the drive rod. The drive rod can have an extension rod to allow the auger to reach the ground in areas close to the truck and allow the auger to dig deeper post holes. The motor can rotate the drive rod and its extension rod in either direction (i.e., clockwise and counterclockwise).

The telephone pole auger is attached to the motor to dig a post hole to set the utility pole. When the hole is dug, the auger is raised from the hole and moved horizontally away from the hole. The auger is then removed from the motor and boom so they can be used to install conventional anchors to further support the utility pole. A Kelly adapter and Kelly bar are attached to the auger motor to install anchors. The boom is used to position the anchors at a desired location, and the motor is used to screw them into the ground. When the anchors are being installed, the telephone pole auger is set aside.

There are two conventional ways to set aside a telephone pole auger while the truck is installing anchors. First, the boom can move the auger to a remote location away from the work area that is reachable by the boom. The utility truck then screws the nine foot auger into the ground to a depth sufficient to keep it from falling over, typically about one to three feet. The auger is left there while the boom is used to install the telephone pole anchors. Securing the auger into the ground can be risky, and is frequently not possible due to surrounding conditions and the limitations of the boom.

Second, an auger can be laid flat or horizontally on the ground while the anchors are installed. The auger is lowered by the boom until the auger tip rests on the ground. Then, a utility worker climbs up the auger and attaches a rope from the free end of the boom to the upper end of the auger shaft. After the worker climbs down, the boom is raised so the auger disconnects from the motor and hangs freely by the rope. Sometimes, the boom is jerked up and down to shake the auger free from the motor, causing the auger to swing. Once the auger comes loose, the boom is lowered and moved horizontally until the auger is lying parallel to the ground. After installing the anchors or performing other necessary tasks, the auger must be reattached to the motor. The rope is reattached to the boom and auger shaft. The boom is raised, so that the auger hangs freely, which can again cause the auger to swing. A worker has to approach and hold the auger vertical while the boom is aligned and lowered until the lower end of the drive rod is matingly inserted into and connects with the top of the auger. The worker then climbs up the auger to remove the rope.

There are a variety of problems with the conventional ways of storing the auger while the truck and boom are used to install anchors or perform other tasks. Problems can arise with screwing the auger into the ground. Ground conditions do not always allow it to be screwed deep enough to prevent it from falling over. This occurs when utility poles are installed near side-walks, streets, landscaping, on private property, or in other places where a second hole cannot be created without repairing the damage this causes. Frequently, there is no place within easy reach of the boom to screw the auger into the ground. Property owner permission is frequently difficult to obtain, and screwing the auger into the ground often damages landscaping that requires repair. These permissions and repairs increase the time and cost of the project. Screwing the auger a foot or more into the ground can also strike an underground electrical wire, cable, water pipe or gas line, which can result in even more costly and serious problems.

Laying an auger on the ground frequently results in a safety concern. The auger can swing when hanging from a rope and workers need to climb the auger and hold it upright. Injury can result from lifting the heavy and unwieldy auger, or if it strikes or falls on a worker. When the ground is not level, the auger can roll and pose a danger to workers or property.

Laying an auger flat on the ground requires more workers and may not be possible given the surrounding conditions. One worker operates the boom while at least one other worker disconnects the auger from the boom or holds the auger vertical so the auger can be reconnected from the boom. A single person cannot safely or efficiently operate the boom and position the auger. Injury can also result when a worker tries to speed up the job by lifting or lowering the heavy auger without the use of the rope There may also be insufficient space nearby where an auger can safely laid down or raised up. If a utility pole is installed near a building, road, tree bush, on a hill, etc., there may not be a place within the range of the boom to safely lay down the auger. Moving the truck to lay down auger is typically time consuming and not a cost effective option.

The present invention is intended to solve these and other problems.

### BRIEF DESCRIPTION OF THE INVENTION

The present invention pertains to an auger stand used in the field to securely hold an auger for digging telephone pole holes in an upright position while a utility truck performs other tasks. The auger stand is formed by base, coupling and strap assemblies. The base assembly includes a central receptacle for inserting the tip of the auger, and several outwardly extending legs to stabilize the stand. The coupling assembly or collar is fixed near the top of the auger shaft away from its helical blade. The strap assembly is formed by several deformable ratchet straps. Each strap has an adjustable elongated working length. One end of each strap is fixed near the outer end of one leg. Its opposed end is secured to the collar. The ratchet straps are tightened to aligned and hold the auger in a substantially vertical or upright position with the auger and stand combining to form a stable pyramid configuration.

One advantage of the present auger stand is improved worker safety. The stand maintains the tall and heavy auger in an upright position so a worker does not have to lift or lower it when removing or securing the auger to the truck boom. The auger is also set into and attached to the auger stand before it is removed from the motor. The additional weight of the stand facilitates removal of the auger from the boom so that jerking the boom and swinging the auger is minimized.

Another advantage of the present auger stand is improved worker efficiency. By utilizing the stand, disconnecting and reconnecting the auger is readily performed by one worker. The worker can use the boom to lower the auger into the receptacle of the auger stand, and then get out of the truck to attach the ratchet straps between the legs and the collar. The worker can then disconnect the auger from the motor, and use the boom to complete other tasks. That same worker can reconnect the auger to the boom by positioning the boom motor over the upright auger, lower the motor onto the top of the auger, and removing the straps to free the auger from the stand. There is no need to lay the boom down or lift it upright, and no need to attach or detach a rope between the boom and the auger. When the stand is used by two or more workers, the overall job efficiency still improves. The portable auger stand itself is readily assembled and disassembled by a single worker. The present auger stand is cost effective as it reduces the need for additional workers.

A further advantage of the present auger stand invention is its versatility. The auger stand folds up to a compact position for storage on the utility truck or for worker to carry. The stand is readily unfolded and setup in most any field condition near the hole for a utility pole. The working length of the ratchet straps is adjustable so the stand can be used on slightly sloped or otherwise uneven ground while maintaining the upright position of the auger. The uphill strap or straps are shortened and the downhill strap or straps are lengthened. Each leg of the stand has an extendable pad to help ensure that each leg sets on the ground. The auger stand also does not dig into the ground so there is no restriction on its use until property owner permission is obtained to allow surrounding landscaping, sidewalks, driveways or streets to be damaged. The portability and adjustability of the auger stand allow its use most anywhere a utility pole is being installed.

A still further advantage of the present auger stand invention is reduced damage to the surroundings and auger itself. No extra damage is caused by digging the auger blades into the ground to store the auger at a field site when the truck boom performs other tasks. The auger tip and blades are not dragged across the ground during attachment or detachment from the boom. There is also no risk of cutting any utility lines or damaging an underground water or gas line. Repairs to unnecessarily damaged landscaping, utility lines and the auger itself am avoided.

Other aspects and advantages of the invention will become apparent upon making reference to the specification, claims and drawings.

### BRIEF DESCRIPTION OF THE DRAWINGS

FIG. 1 is a perspective view of a utility truck having a boom equipped with an auger for digging telephone pole holes, where the auger is aligned over an auger stand including a base frame and ratchet straps, and where the stand also includes a shaft collar secured to the auger hanging pendent from the boom.

FIG. 2 is a perspective view of the assembled auger stand holding the auger 10 in its generally upright position while the utility truck and boom are used to install anchors into the ground around a post hole.

FIG. 3 is an enlarged, perspective view showing the auger stand folded and stored in the truck.

FIG. 4 is a perspective view of the assembled, pyramid shaped auger stand holding an auger in an upright position.

FIG. 5 is an exploded view the auger stand of FIG. 4.

FIG. 6 is a view of the auger stand folded more compactly.

FIG. 7 is an enlarged, perspective view of the base frame assembly of the auger stand.

### DETAILED DESCRIPTION

While this invention is susceptible of embodiment in many different forms, the drawings show and the specification describes in detail a preferred embodiment of the invention. Still, it should be understood that the drawings and specification are to be considered an exemplification of the principles of the invention. They are not intended to limit the broad aspects of the invention to the embodiment illustrated.

Telephone or utility poles are installed in the ground 5 for all types of terrain and a wide variety of rural, suburban or city environments. Because of the size and weight of the pole and components involved in installing the poles, conventional utility trucks 6 are commonly used to install them. The trucks 6 are equipped with a mechanical boom 7 operated by a worker via a control panel in the truck. One end of the boom 7 is secured to the truck 6. The free end of the boom 7 is equipped with a motor 8 adapted to hold and power a variety of implements. The boom 7 rotates laterally and up and down about its fixed end, and includes two or more telescoping members.

A worker selectively rotates the boom 7 side-to-side and up and down, and tangentially extends or retracts the boom to position its free end and motor 8 to a desired position. The truck 6 supplies power down the length of the boom 7 to the motor 8 via a conventional rotating drive rod mechanism, hydraulic lines or electrical cables. The motor 8 has an output or drive rod 9. The drive rod 9 is selectively rotatably driven by the motor 8 via the worker at the control panel in the truck 6. The drive rod 9 has a hexagon or otherwise contoured cross sectional shape adapted to matingly and drivingly connect to various work implements, such as an auger 10.

Conventional augers 10 for digging telephone post holes are about nine feet tall and weigh about 350 pounds. The auger 10 has a central linear shaft 11 that extends the length of the auger. The auger has an upper securement portion 12 and a lower working portion 13. The upper portion 12 has a flat top surface with a four inch diameter hexagon shaped or otherwise contoured recess 14. The hexagon recess 14 is adapted to drivingly mate with the hexagon shaped drive rod 9 of the motor 8. During use, the auger 10 is rigidly and drivingly connected to the drive rod 9 via this recess 14 and a detachable locking pin 15. This is done by inserting the drive rod 9 into the like-shaped shaft recess 14. When holes in the top of the shaft 11 and the drive rod 9 align, a locking pin 15 is inserted through them. When secured in this manner, the motor 8 imparts rotational torque or power to the auger shaft 11 via its drive rod 9. The lower working portion 13 of the auger 10 has a helical blade 16 for digging post holes. The blade 16 has a relatively constant diameter through the majority of its length, but narrows to a point near its tip 17 at the bottom of the shaft 11.

The boom motor 8 rotates the auger 10 and its helical blade 16 to dig a post hole 20 in the ground 5 for inserting a telephone pole 21. Telephone poles or posts 21 are typically 40 to 45 feet tall, but can range from 24 to 70 feet depending on their use. The hole 20 is slightly wider than the pole 21, and are typically five to seven feet deep. The buried portion of the pole 21 is inserted into the hole 20. Anchors 22 are drilled into the ground 5 a desired distance from the pole 21. Support wires 23 are secured to the pole 21 several feet above the ground 5. The opposed end of each support wire 23 is secured to one of the anchor 22 to provide additional support for the pole 21.

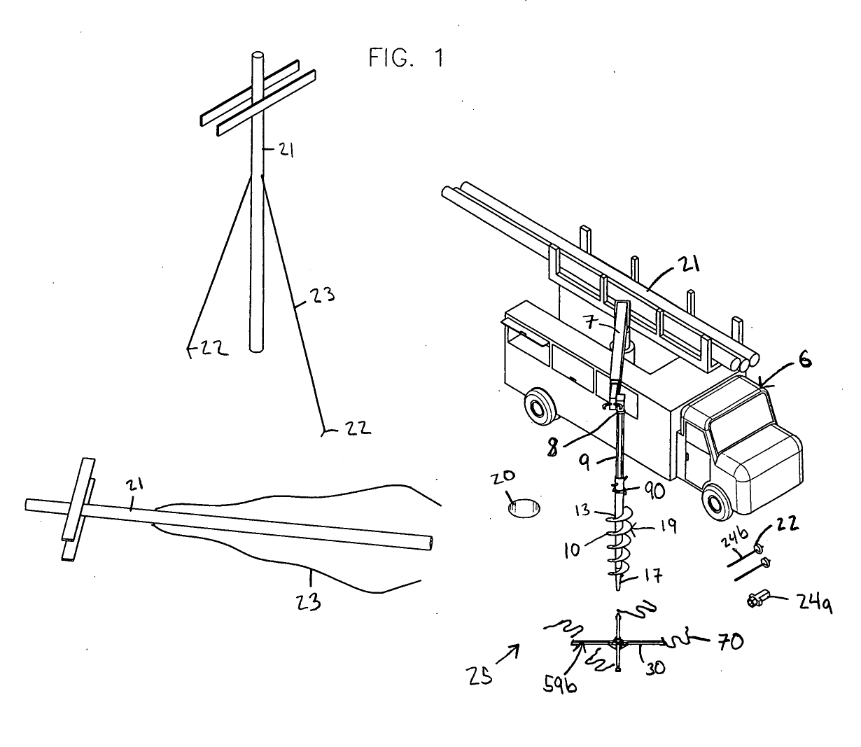

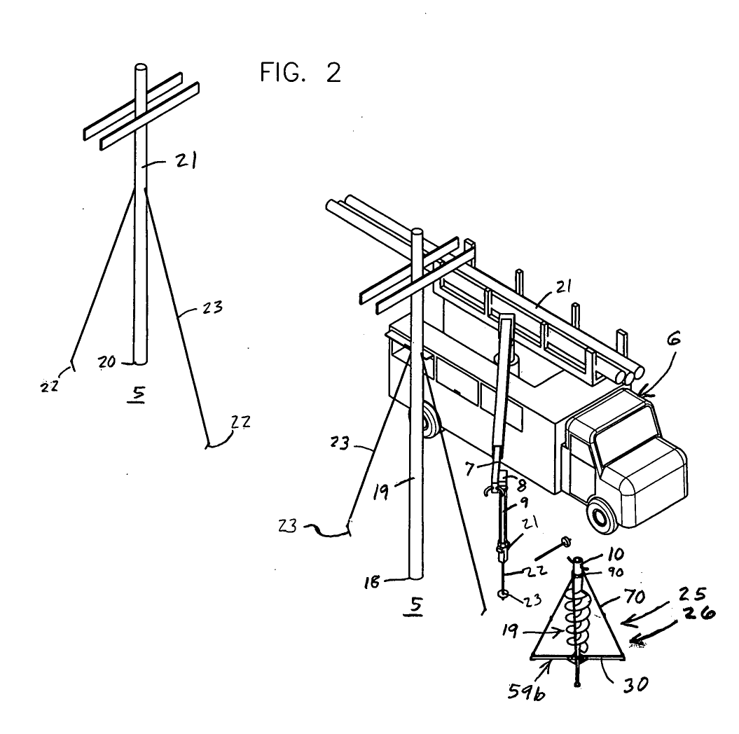

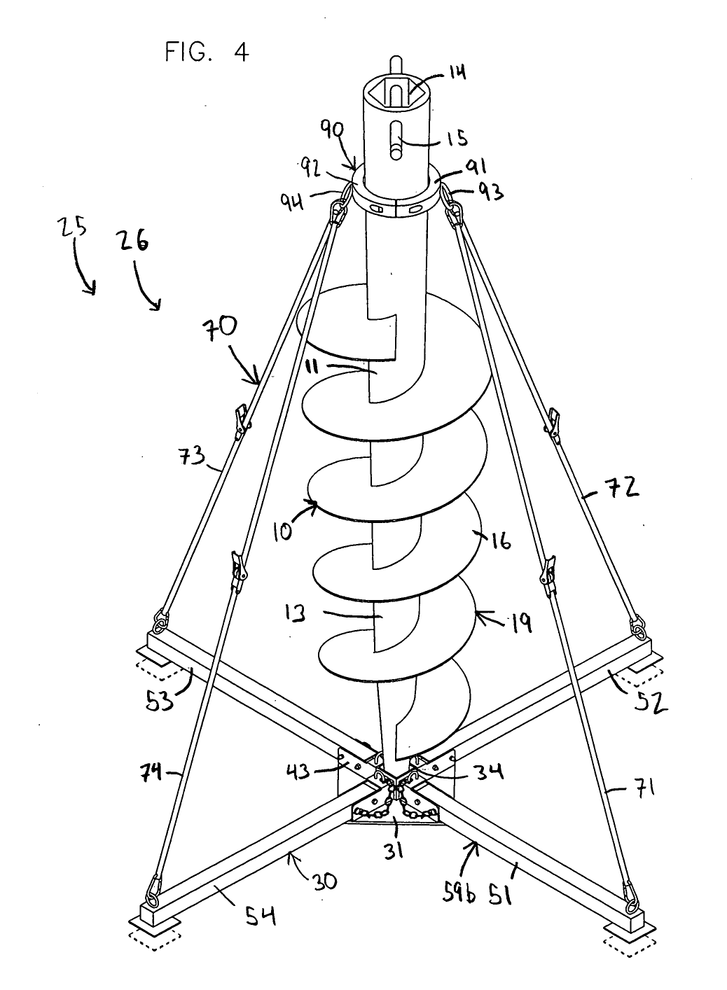

The present invention relates to a stand for an auger for digging telephone pole holes as generally indicated by reference number 25 and shown in drawing FIGS. 1-7. The auger stand 25 has a variety of components including a base frame assembly 30, a ratchet strap assembly 70, and an auger shaft collar 90. The collar 90 is secured to an elevated location on the shaft 11 of an auger 10 that hangs pendent or vertically from the boom motor 8 as shown in FIG. 1. When the auger 10 is placed on the stand 25 and the stand is assembled, the ratchet strap assembly 70 forms a pyramid shape with the collar 90 at the top of the overall pyramid shaped structure 26 as shown in FIGS. 2 and 4. The fully assembled auger stand 25 holds the auger 10 in its generally upright or vertical position while the utility truck 6 and boom 7 are used to install anchors 22 into the ground 5 around a post hole 20. The auger stand 25 holds the auger 10 vertically to facilitate its connection to and removal from the output shaft or extension rod 9 of the truck boom motor 8.

The base assembly 30 includes a central plate 31 with upper and lower surfaces 32 and 33, a central receptacle 34 for receiving the tip of the auger 10, and four like-shaped leg mounting brackets 41-44. The plate 31 is flat and forms about a 14 inch square. The lower surface 33 of the plate 31 is adapted to lay flat on the ground 5 during use. The receptacle 34 is located at the center of the plate 31 and extends from its upper surface 32. The receptacle 34 is about three inch deep and forms a 3½ inch square. The plate perimeter 35 has corners 36-39. The square receptacle 34 is rotated about 45° relative to the square plate 31 so that the receptacle walls face the plate corners 36-39. The receptacle 34 and brackets 41-44 are welded or otherwise rigidly secured to the base plate 31. The rear end of each bracket 41-44 flushly abuts a wall of the receptacle 34, and the bracket extends radially toward the plate corners 36-39. Each bracket 41-44 forms an outward facing slot to receive one base leg 51, 52, 53 or 54. Each bracket 41-44 secures one leg 51-54 to the base assembly 30. The base frame 30 components are preferably metal and painted, coated, or otherwise treated to inhibit rust and corrosion.

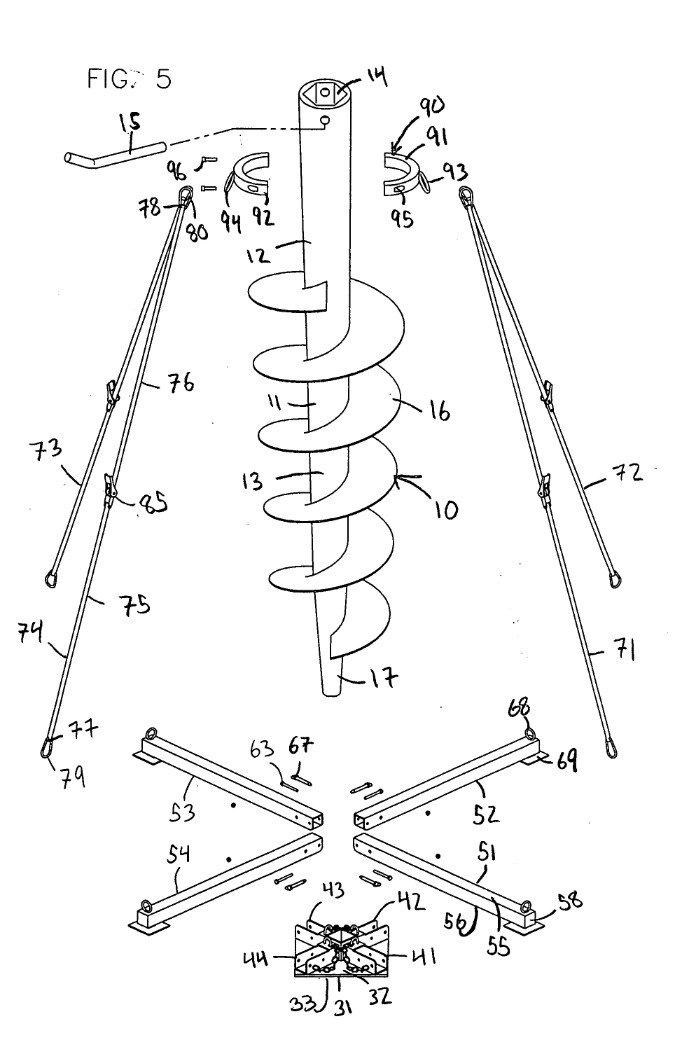

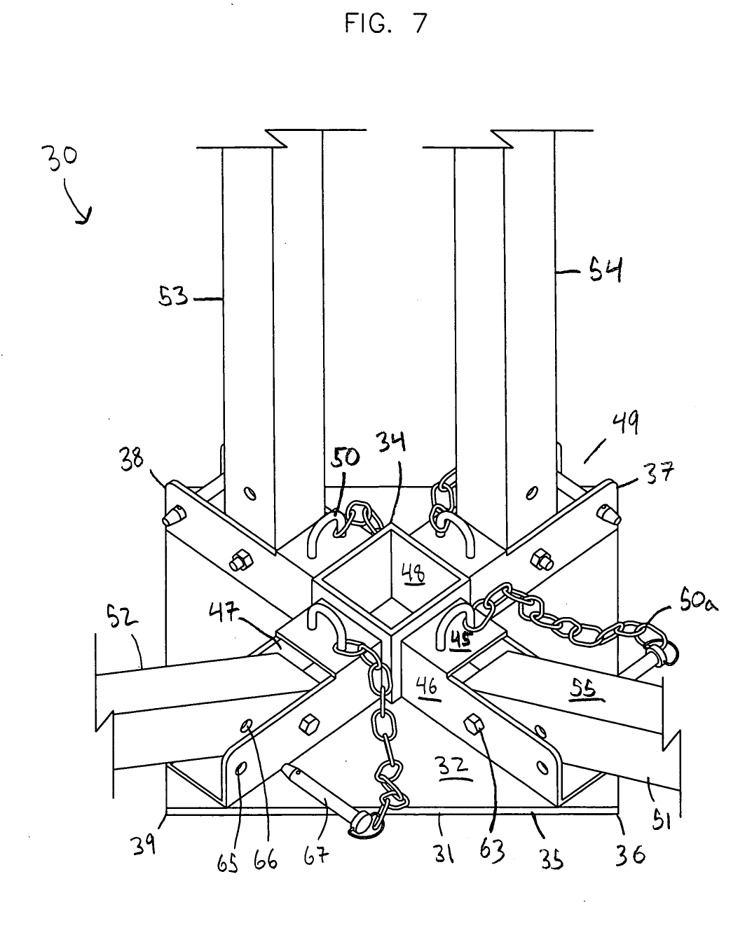

The four leg brackets 41-44 are equally spaced at 90° increments around the plate 31 to form an outer framework to maintain the auger 10 in an upright position 59b. As best shown in FIGS. 5 and 7, each bracket 41-44 extends from the center receptacle 34 toward a corresponding plate corner 36-39. Each bracket 41-44 has walls 45-48 that form an open outer end 49. The lower wall 46 lays flat on the upper surface of the plate 31. The upper wall 46 is shorter than the side walls 47 to form an upper opening to allow the legs to fold up when the stand 25 is carried or stored on the truck 6. The sidewalls 47 are spaced apart to flushly receive one of the legs 51-54. The sidewalls 47 extend from the center receptacle 34 to the perimeter 35 of the plate 31. The inner wall 48 abuts the center receptacle 34. Each open outer end 49 faces a corresponding plate corner 36-39. The outer openings 49 allow the legs 51-54 to extend radially outward from the base plate 31 to form a stable planar structure to set on the ground 5 during use as in FIGS. 1, 2 and 4. Each upper wall 46 has a bracket ring 50 to connect several locking pins and ratchet straps when the stand 25 is carried by a worker or stored as discussed below. While the base assembly 30 preferably includes folding legs 51-54 to form a stable platform, it should be understood that other types of props to form a stable outer framework of platform can be used without departing from the broad aspects of the invention.

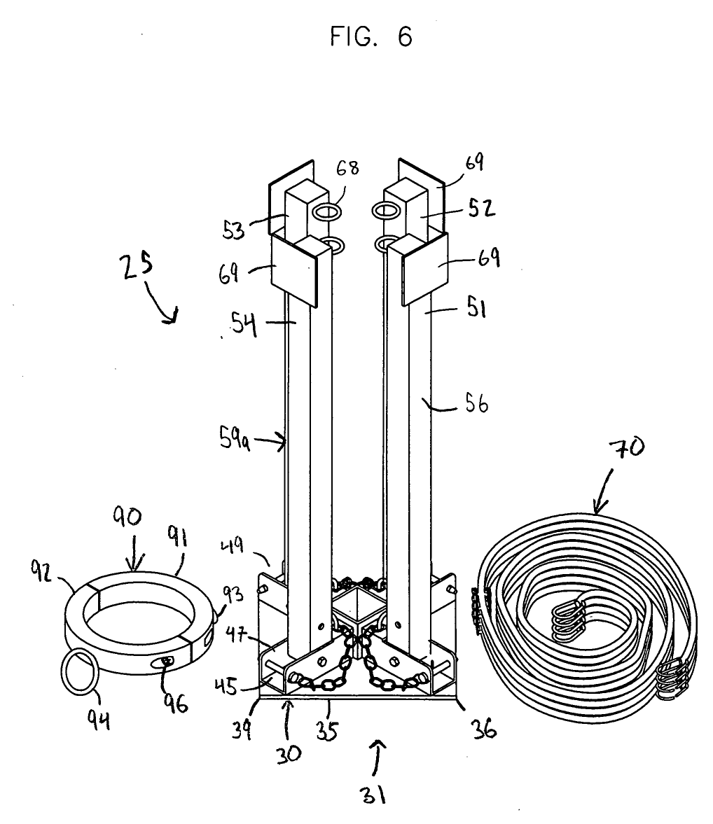

Each leg 51-54 has a uniform, three inch square cross section with upper 55 and lower 56 surfaces, and a length of about three feet with inner 57 and outer 58 ends. Each leg 51-54 is secured to its corresponding bracket 41-44 via leg pivoting and leg locking mechanisms 60 and 64. Leg pivoting mechanism 60 is formed by opposed pivot holes 61 on the sidewalls 47 of each bracket 41-44, a leg pivoting hole 62 on the inner end 57 of each leg 51-54 and a pivot pin 63. These bracket and leg holes 61 and 62 are linearly aligned to receive pivot pin 63. Pivot pin 63 pivotally secures the legs 51-54 to the base frame 30. Pivot pin 63 remains inserted when the stand 25 is folded 59a for storage and transport and when extended 59b to hold an auger 10 during use in the field. The pin 63 has a head on one end and is secured in place via a nut and washers on its other threaded end. The pivot mechanism 60 allows the stand 25 to fold up 59a more compactly with its legs 51-54 coming into close parallel alignment as in FIG. 6, and fold out to its extended position 59b where the legs are substantially planar and extend radially from the base plate 31 as in FIGS. 2 and 4.

During use, each leg 51-54 is extended to its auger holding position 59b. A leg locking mechanism 64 is then engaged to lock the legs 51-54 in their extended position. The leg locking mechanism 64 is formed by opposed locking holes 65 on the sidewalls of brackets 41-44 that align with a leg locking hole 66 on the leg 51-54 and a leg locking pin 67. The leg locking pin 67 is located about one to three inches outwardly from their corresponding pivot pin 63. When the legs 51-54 are in the horizontal or open position 59b, the leg locking holes 65 and 66 align and the leg locking pin 67 is inserted. The pivot pins 63 and locking pins 67 secure the legs 51-54 in their extended position 59b as in FIG. 4 and prevent them from folding. One end of the leg locking pin 67 has a head and its opposed end has a hole for a cotter pin to be inserted to secure the pin 67 in place. Each removable locking pin 67 is attached to its bracket ring 50 by a chain 50a so the pin remains with the stand 25 during field use and storage.

Each leg 51-54 has a ratchet securement mechanism or ring 68 rigidly fixed to its upper surface 55 near its free end 58. Each leg also has a ground engaging pad 69 secured to its lower surface 56 near its free end 58. Each ring 68 connects the end of one ratchet strap 71-74 when the legs 51-54 are extended 59b. The straps preferably remain connected to the ring 68, but can be removed from them when stored 59a. When the legs 51-54 are extended 59b during use, their pads 69 rest on the ground 5. Each leg pad 69 is threadably attached to the lower surface 56 of its leg 51-54 so the pad can be adjustably extended or retracted to accommodate for uneven ground conditions in the field to increase the stability of the stand 25.

The coupling assembly or collar 90 includes two mating U-shaped coupling halves 91 and 92. One securing mechanism or ratchet ring 93 or 94 is rigidly fixed to each coupling half 91 and 92. Preferably, one collar half 91 has threaded holes 95 at its ends that align with unthreaded holes at the ends of the other collar half 92 to join them together via a pair of bolts 96. The collar halves 91 and 92 are sized to flushly and firmly attach to the upper portion 12 of the auger shaft 11. The bolts 96 are tightened to firmly secure the collar 90 below the auger locking pin 15 so it does not interfere with the augers 10 attachment or detachment from the drive rod 9. The coupling assembly 90 is fixed to the auger shaft 11 when the auger 10 is held by the stand 25, and can remain fixed to the auger when it is secured to the drive rod 9 and digging a post hole 20, and even when the auger 10 is stored on the truck 6 or in a warehouse. The collar 90 is preferably metal and painted, coated, or otherwise treated to inhibit rust and corrosion.

Ratchet strap or auger securing assembly 70 connects to the leg rings 68 and collar rings 93 and 94 to form a pyramid shaped structure 26 that holds the auger 10 in a substantially vertical or upright position 19 as shown in FIGS. 2 and 4. The auger collar 90 forms the top of the pyramid structure 26. The auger securing assembly 70 preferably includes four conventional ratchet straps 71-74. Each strap 71-74 has a leg portion 75 with a leg end 77, and a collar portion 76 with a collar end 78. A ratchet 85 joins the strap portions 75 and 76 of each strap 71-74. The ratchet 85 adjusts the overall length of its strap 71-74 by securely drawing the portions 75 and 76 together. The leg end 77 of each strap 71-74 has a leg snap or hook 79 to connect the strap 71-74 to one of the leg rings 68. Similarly, the collar end 78 of each strap 71-74 has a collar snap or hook 80 to connect the strap 71-74 to one of the collar rings 93 and 94. When the base assembly 30 is set on the ground 5, its legs 51-54 are unfolded about pivot pin 63 to an extended position 59b and locked into place via locking pin 67. An auger 10 placed on the stand by a truck boom 7 in an upright position 19 with its tip 17 in the receptacle 34. Each strap 71-74 is joined to its respective leg and collar rings 68 and 93 or 94. Each strap 71-74 forms an angled edge of the fully assembled overall pyramid shaped structure 26 of the auger stand 25. While the auger securing assembly 70 is preferably formed by ratchet straps 71-74 it should be understood that other types of adjustable elongated members can be used without departing from the broad aspect of the invention.

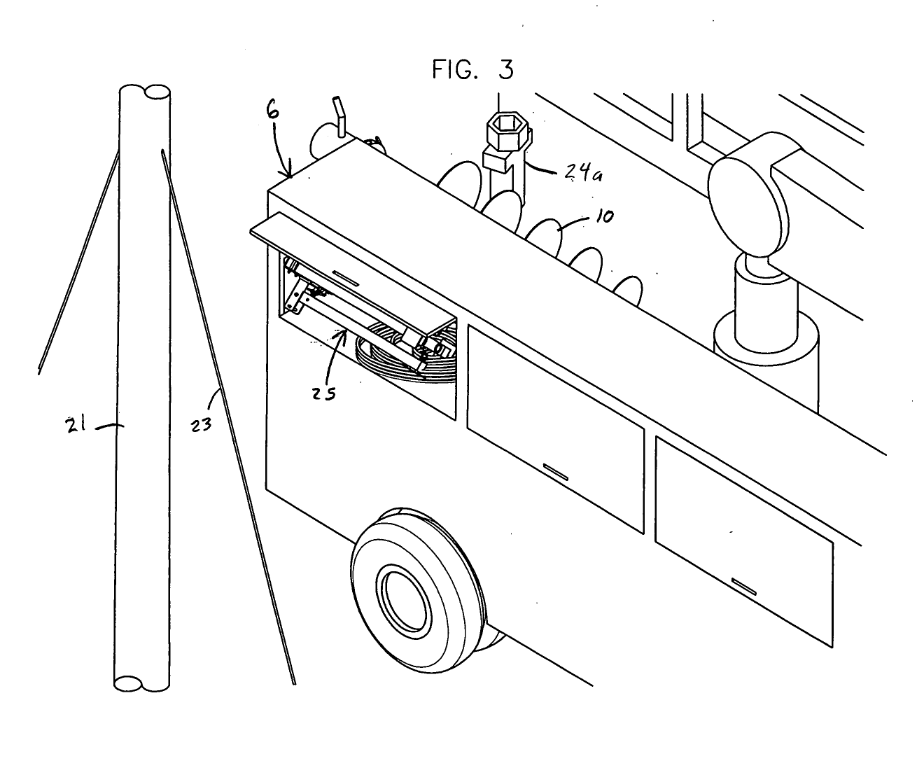

Although the operation of the auger stand 25 should be apparent from the above description, the following is provided to further facilitate the reader. During operation, the auger is typically already attached to the boom 7 to dig a first hole 20 as in FIG. 1. The folded 59a auger stand 25 is removed from the truck 6 as in FIG. 3 and carried to a desired field location accessible by the truck boom 7. The base plate 31 of the stand 25 is set on the ground 5 and the legs 51-54 are unfolded 59b so they extend radially outward to form a planar platform. The legs 51-54 are unfolded by first removing bracket locking pin 67 from locking holes 65 and 66. The legs 51-54 are then rotated downwards to a horizontal or open position 59b. The leg locking pin 67 is then reinserted though the locking hole 65 and 66 to lock the legs in place. The leg pads 69 are then adjusted so that each pad engages the ground 5. The ratchet coupling snaps 80 are detached from the leg bracket rings 50, and the coupling end portion 76 of the straps 71-74 are set aside as in FIG. 1.

The auger stand 25 is now ready to receive the auger 10. While the auger 10 is still attached to and hanging vertically pendent 59b from the motor 8, the worker uses the boom 7 to locate the auger over the stand 25 as in FIG. 1. The partially assembled stand 25 can also be moved to position it under the auger 10. After the auger tip 17 is directly over central receptacle 34 of the stand 25, the boom 7 lowers the auger 10 so its tip 17 is received by the receptacle and the weight of the auger 10 rests on the stand. The auger 10 remain in its vertically or upright position. If not already done, the coupling assembly 90 is firmly secured to the upper portion 12 of the auger shaft 11.

The ratchet straps 71-74 are then connected to the collar 90. Ratchet coupling snaps 80 are attached to the coupling rings 93 and 94 of the coupling assembly 90 on the upper portion 12 of the auger shaft 11. Ratchet straps 71 and 72 are attached to coupling ring 93, and ratchet straps 73 and 74 are attached to coupling ring 94. The ratchets 85 on each strap 71-74 are then tightened to stabilize the auger 10 in its upright and vertical position 59b. The auger 10 is then detached from the motor output or extension rod 9 by removing locking pin 15, and raising the boom 7 until the bottom end of the motor 8 output or extension rod 9 is removed from the recess 14 in the top of the auger 10. Should the contoured end of rod 9 bind with and not release from auger recess 14, the weight of the stand 25 facilitates the detachment of the auger from the drive rod. The truck 6 and boom 7 are now free to install anchors 22 or perform other necessary tasks as in FIG. 2.

After digging the pole hole 20, one or more anchors 22 are installed at spaced locations around the hole via the boom 7 and motor 8. To do this, the auger 10 is disconnected from the drive rod 9 by removing locking pin 15 and lifting the rod 9 out of the recess 14 of the auger shaft 11. A kelly bar adapter 24a is then attached to the drive rod 9 for securing a kelly bar 24b. One anchor 22 is attached to kelly bar 24b. Each anchor 22 has blades at the end for digging itself into the ground 5. The boom 7 and motor 8 are used to install the anchors 22.

When the pole anchors 22 are installed, the auger 10 is reattached to the truck boom 7 to dig another post hole 20. The boom is positioned to aligned the motor output or extension rod 9 over the auger 10 being held upright in the stand 25. The boom 7 is lowered until the contoured end of the motor output or extension rod 9 matingly engages the auger shaft recess 14. The locking pin 15 is then inserted to secure the auger 10 to the motor 8. Then, ratchet coupling snaps 80 are detached from the collar rings 93 and 94. The boom 7 is then raised to disengage the motor output or extension rod 9 from the recess 14 in the top of the auger 10.

The auger stand 25 is easily folded up 59a to facilitate its transport and storage. Each coupling snap 80 of the ratchet straps 71-74 is detached from its coupling ring 93-94 and is attached to its corresponding leg bracket ring 50. The ratchet 85 is then used to tighten the ratchet straps 71-74 to eliminate or reduce the slack in the strap for storage. The legs 51-54 are folded into a stored position 59a by removing the leg locking pin 67 and rotating the legs 51-54 into an overlapping parallel alignment. The leg locking pin 67 is then reinserted in the bracket locking hole 65 and secured with its cotter pin. The auger stand 25 is then easily carried by a worker and stored on the truck 6 or any other convenient location.

While the invention has been described with reference to a preferred embodiment, it will be understood by those skilled in the art that various changes may be made and equivalents may be substituted without departing from the broader aspects of the invention. For example, although the motor is shown with a drive rod extension 9, it should be understood that the output shaft of the motor 8 can be connected to the auger recess 14 without the use of this extension 9. Similarly, although the auger stand has been shown and described as having four brackets 41-44, legs 51-54 and ratchet straps 71-74, each being uniformly spaced 90° apart around the base plate 31, it should be readily understood that the invention would also encompass embodiments with three brackets, legs and ratchet straps or five or more brackets, legs and ratchet straps.

I claim:

1. An auger stand for a utility truck that installs telephone poles in the ground, the utility truck having a telescoping boom with a motor fixed to its free end, the motor having a drive rod with a contoured end, an auger hanging vertically pendent from the drive rod of the motor, the auger having an auger shaft, the auger shaft having a lower working portion with a cutting tip and an upper securing portion with a top surface, the top surface of the auger shaft having a contoured recess adapted to matingly receive the contoured end of the drive rod, the auger being drivingly securable to the motor by lowering the contoured end of the drive rod into mated engagement with the contoured recess of the auger shaft, the auger stand comprising:
a base assembly having a central retainer and at least three props joined to and extending radially outward from said retainer at spaced locations around said retainer to form a generally planar platform adapted to lay on the ground, each prop having an outer end, and said retainer being adapted to receive the cutting tip of the auger shaft and support the weight of the auger;
a collar adapted to firmly attach to the upper portion of the auger shaft below its said top surface, said collar being spaced vertically from the cutting tip of the auger a distance greater than the working portion of the auger;
an auger securing assembly formed by at least three adjustably elongated members, each of said props having one associated elongated member, each elongated member having first and second ends, each of said first ends being secured to said outer end of one of said props, and each of said second ends being secured to said collar to form a pyramid shaped structure, said pyramid shaped structure holding the auger in an upright position; and,
wherein the top surface of the auger shaft is unobstructed by said auger stand to allow lowering the boom to engage the contoured end of the drive rod with the contoured recess of the auger shaft when said auger stand is holding the auger in said upright position.

2. The auger stand of claim 1, and wherein said adjustable elongated members are ratchet straps, said ratchet straps being selectively tightened to tautly hold the auger in its said upright position.

3. The auger stand of claim 2, and wherein said props are legs, and said legs are pivotally secured to said retainer and fold out to extend radially from said retainer to form said generally planar platform, and said legs fold up into a substantially parallel alignment for storage and transport.

4. The auger stand of claim 3, and wherein said base assembly includes a locking mechanism to lock said legs in their said extended position.

5. The auger stand of claim 4, and wherein said outer end of each leg included a leg ring, said collar includes at least two collar rings, and each said ratchet strap has a first portion with a leg clip and a second portion with a collar clip, each said leg clip being attached to said leg ring, and each said collar clip being attached to one of said collar rings.

6. The auger stand of claim 5, and wherein said base assembly includes four legs equally spaced at 90° degree intervals around said retainer, and said auger securing assembly includes four ratchet straps.

7. The auger stand of claim 6, and wherein the auger is about 9 feet tall and weighs about 350 pounds, said collar is secured to the upper securing portion of the auger shaft at least five feet above the cutting tip of the auger shaft, and each of said legs is about 3 feet long.

8. The auger stand of claim 7, and wherein said base assembly includes a central reinforcing plate with an upper surface and at least three brackets, said central reinforcing plate extending radially outward beyond said retainer, said retainer being flushly secured to said upper surface of said reinforcing plate, each of said legs being pivotably joined to said retainer via one of said brackets, each said bracket being secured to the upper surface of said plate in abutting engagement with said retainer.

9. The auger stand of claim 7, and wherein each of said legs fold out by rotating about a pivot pin held by one of said brackets, and said locking mechanism is a locking pin spaced outwardly from said pivot pin, said locking pin being removably held by said bracket.

10. The auger stand of claim 1, wherein the collar forms a top of said pyramid shaped structure and said elongated members form angled edges of said pyramid shaped structure.

11. The auger stand of claim 1, wherein the contoured end of the drive rod of the motor drivingly connects to an extension rod, the extension rod having a contoured end, the contoured end of the recess of the auger shaft being adapted to matingly receive the contoured end of the extension rod.

12. The auger stand of claim 1, wherein each said outer end of said legs has a securement mechanism, said collar has at least two securement mechanisms, said first ends of said elongated members have leg securement mechanisms to selectively connect to said securement mechanisms of said legs, and said second ends of said elongated members have collar securement mechanisms to selectively connect to said securement mechanisms of said collar.

13. The auger stand of claim 11, wherein said securement members of said legs and collar are rings, and said leg and collar securement members of said elongated members are clips, said clips being selectively removable from said rings.

14. A method of using an auger stand for a utility truck that installs telephone poles in the ground, said method of using an auger stand for a utility truck comprising the following steps:
providing a utility truck with an auger, said utility truck having a telescoping boom with a motor fixed to its free end, said motor having a drive rod with a contoured end, said drive rod hanging pendent from said motor, said auger having an auger shaft with a lower working portion with a cutting tip and an upper securing portion with a top surface, said top surface of said auger shaft having a contoured recess adapted to matingly receive said contoured end of said drive rod, said auger being drivingly secured to said drive rod by inserting said contoured end into mated engagement with said contoured recess and inserting a locking pin through said mated contoured end and recess to lock said auger to said drive rod, said auger hanging vertically pendent from said drive rod;
providing an auger stand having a base, a collar and an auger securing assembly, said base having a central retainer and at an outer framework extending around said retainer, said auger securing assembly having at least three elongated members, each elongated member having first and second ends, each of said first ends being secured to said outer framework at equally spaced locations around said framework;
securing said collar to said upper portion of said auger shaft below its said top surface, said collar being spaced vertically from said cutting tip a distance greater than said working portion of said auger;
using said boom, motor and auger to dig a post hole for the telephone pole at a desired location;
placing said auger stand at a desired location away from said post hole and accessible by said boom;
aligning said auger stand with said auger hanging pendent from said motor, said tip of said auger shaft being positioned directly above said retainer of said auger stand;
lowering said boom to place said auger onto said auger stand, said tip of said auger shaft being received by said retainer;
securing each of said second ends of said elongated members to said collar to hold said auger in an upright position, said auger being in held engagement by said auger stand;
removing said locking pin securing said auger to said drive rod;
raising said boom to move said contoured end of said drive rod up and out of engagement with said contoured recess of said auger, said auger being supported by said auger stand and said auger remaining in said upright position;
using said boom to perform another task;
aligning said drive rod of said motor with said auger being held by said auger stand, said contoured end of said drive rod being positioned directly above said contoured recess of said auger shaft;
lowering said boom to move said contoured end of said drive rod down and into mated engagement with said contoured recess of said auger;
inserting said locking pin to secure said auger to said drive rod;
detaching each of said second ends of said elongated members from said collar to release said auger from its held engagement by said auger stand;
raising said boom to lift said auger off said auger stand.

15. The method of using an auger stand for a utility truck of claim 14, and wherein said outer frame of said base is at least three radial outwardly extending legs, and each of said legs is secured to one associated elongated member,

16. The method of using an auger stand for a utility truck of claim 14, and wherein said other task is installing anchors for the telephone pole.

17. The method of using an auger stand for a utility truck of claim 14, and wherein said stand forms a pyramid shaped structure to hold said auger in said upright position.

18. The method of using an auger stand for a utility truck of claim 14, and wherein said elongated members of said auger securing assembly are ratchet straps and said step of securing each of said second ends of said elongated members includes tightening said ratchet straps taut.

19. The method of using an auger stand for a utility truck of claim 14, and wherein the steps of using, placing, aligning, lowering, securing, removing, raising, using, aligning, lowering, inserting, detaching and raising are repeated to dig another post hole for another telephone pole.
